(19) United States
(12) Patent Application Publication
(10) Pub. No.: US 2024/0095819 A1
(43) Pub. Date: Mar. 21, 2024

(54) GRAPHICAL USER INTERFACES FOR MANAGING RESOURCE ACCOUNTS

(71) Applicant: The Toronto-Dominion Bank, Toronto (CA)

(72) Inventors: Anil Stewart BAKHLE, Guelph (CA); Ronald Allan KIELSTRA, Beamsville (CA); Grace Yip, Stouffville (CA); Lyn Michelle CRUZ, Whitby (CA)

(73) Assignee: The Toronto-Dominion Bank, Toronto (CA)

(21) Appl. No.: 17/946,154

(22) Filed: Sep. 16, 2022

(51) Int. Cl. G06Q 40/02

(52) U.S. Cl. CPC G06Q 40/02

(57) ABSTRACT

A computer-implemented method is disclosed. The method includes: obtaining historical operations data for a resource account, the historical operations data identifying account operations performed by a user in connection with the resource account; generating display data for a graphical user interface for accessing the resource account, the display data including user interface elements associated with a first set of highest priority account operations that are selected based on the historical operations data for the resource account; obtaining user engagement data representing user interaction with the graphical user interface, the user engagement data identifying at least one account operation; identifying a second set of highest priority account operations based on the user engagement data; generating updated display data for the graphical user interface associated with the second set of highest priority account operations; and providing, to a client device for display thereon, the updated display data.

### TECHNICAL FIELD

The present application relates to user interfaces and, more particularly, to methods of providing graphical user interfaces that are used for managing resource accounts.

### BACKGROUND

Traditional banking user interfaces, such as websites, mobile apps, etc., provide static display of account information and limited options for accessing banking features and actions. By way of example, a home page for a bank account may display a list of accounts (e.g., chequing account, savings account, and the like), account balances for each of the listed accounts, and options for accessing account operations and settings in connection with one or more of the listed accounts. The displayed account information, including user interface elements associated with available account actions, may be statically arranged on the home page. In particular, account information may be displayed in accordance with a default user interface design for the home page.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for providing a graphical user interface associated with a resource account management platform;

FIG. 4 shows, in flowchart form, an example method for real-time control of a graphical user interface associated with a resource account management platform;

FIG. 5 shows, in flowchart form, an example method for determining feature priority scores of features associated with a resource account management platform; and

FIG. 6 shows, in flowchart form, another example method for real-time control of a graphical user interface associated with a resource account management platform.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores computer-executable instructions that, when executed by the processor, configure the processor to: obtain historical operations data for a resource account, the historical operations data identifying account operations performed by a user in connection with the resource account; identify a first set of highest priority account operations based on the historical operations data for the resource account; generate display data for a graphical user interface for accessing the resource account, the display data including user interface elements associated with the first set of highest priority account operations; obtain user engagement data representing user interaction with the graphical user interface, the user engagement data identifying at least one account operation; identify a second set of highest priority account operations based on the user engagement data; generate updated display data for the graphical user interface associated with the second set of highest priority account operations; and provide, to a client device for display thereon, the updated display data.

In some implementations, the historical operations data for the resource account may comprise one or more banking operations performed in connection with a bank account.

In some implementations, the first and second sets of highest priority account operations may be determined based on assigning priority scores to each of one or more account operations associated with the resource account.

In some implementations, a priority score for an account operation may be determined based on the user engagement data indicating at least a frequency of the account operation and a duration of the account operation.

In some implementations, a priority score for an account operation may be determined based on user-defined positional coordinates of a user interface element corresponding to the account operation on the graphical user interface.

In some implementations, a priority score for an account operation may be determined based on a metric for measuring a difference in profile between an owner of the resource account and a defined profile for a product associated with the account operation.

In some implementations, the user engagement data may indicate user actions for manipulating user interface elements corresponding to one or more of the account operations associated with the resource account.

In some implementations, generating the updated display data may include determining a modified order of presenting user interface elements corresponding to one or more of the account operations associated with the resource account.

In some implementations, the modified order of presenting the user interface elements may be determined based on priority scores associated with account operations for the resource account.

In some implementations, the user interface elements may be presented in decreasing order of priority scores associated with the corresponding account operations.

In another aspect, a computer-implemented method is disclosed. The method includes: obtaining historical operations data for a resource account, the historical operations data identifying account operations performed by a user in connection with the resource account; identifying a first set of highest priority account operations based on the historical operations data for the resource account; generating display data for a graphical user interface for accessing the resource account, the display data including user interface elements associated with the first set of highest priority account operations; obtaining user engagement data representing user interaction with the graphical user interface, the user engagement data identifying at least one account operation; identifying a second set of highest priority account operations based on the user engagement data; generating updated display data for the graphical user interface associated with the second set of highest priority account operations; and providing, to a client device for display thereon, the updated display data.

In yet another aspect, a non-transitory computer-readable storage medium is disclosed. The storage medium contains instructions thereon which, when executed by a processor, configure the processor to: obtain historical operations data for a resource account, the historical operations data identifying account operations performed by a user in connection with the resource account; identify a first set of highest priority account operations based on the historical operations data for the resource account; generate display data for a graphical user interface for accessing the resource account, the display data including user interface elements associated with the first set of highest priority account operations; obtain user engagement data representing user interaction with the graphical user interface, the user engagement data identifying at least one account operation; identify a second set of highest priority account operations based on the user engagement data; generate updated display data for the graphical user interface associated with the second set of highest priority account operations; and provide, to a client device for display thereon, the updated display data.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application relates to user interfaces and, more particularly, to methods for dynamically providing account information on a graphical user interface. A resource account management platform may provide users access to various functions for managing their resource accounts. As a specific example, traditional banking user interfaces provide static display of account information and limited options for accessing banking functions. A home page for a bank account may display a list of accounts (e.g., chequing account, savings account, and the like), account balances for each of the listed accounts, and options for accessing account operations and settings in connection with one or more of the listed accounts. The displayed account information, including user interface elements associated with available account actions, may be statically arranged on the home page. In particular, the account information may be displayed in accordance with a default user interface design for the home page. The overall layout and arrangement of specific user interface elements may be fixed, and only the user-specific information (e.g., account balances, transaction history, etc.) may be varied as part of the display information associated with users' accounts.

A fixed user interface design scheme may be inadequate for providing a productive user experience in managing resource accounts. Different users may have different priorities or preferences in regard to access of account-related features, user interface functions, and visual display of account information. A user interface for account management that imposes a common design for all users may not support the full range of users' priorities and preferences. In particular, an account management platform that provides a common, static user interface for its users may cause the users to experience delays in executing desired account actions, have difficulty in locating relevant account information, and be unable to access the full suite of functions that are offered by the platform.

Various technical solutions for providing customized user interfaces for managing resource accounts are described in the present disclosure.

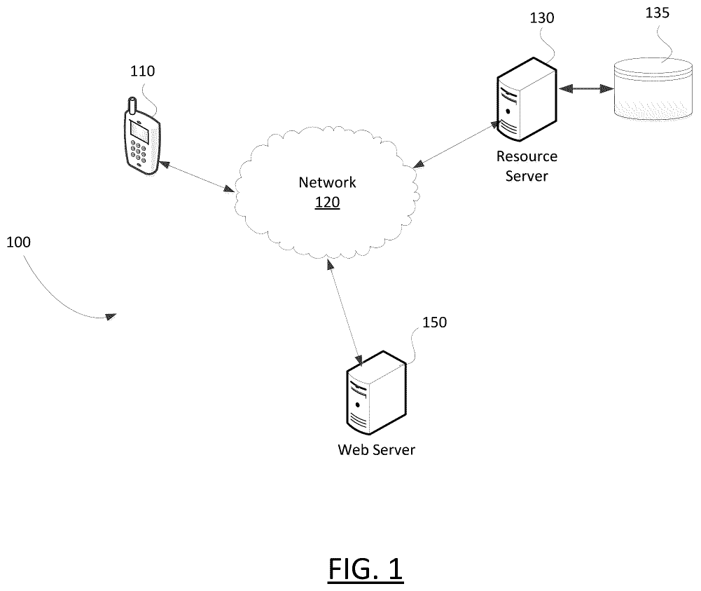

FIG. 1 illustrates an exemplary computing environment 100 consistent with certain disclosed embodiments. The computing environment 100 may include one or more client devices 110, a resource server 130, a database 135 associated with the resource server 130, a web server 150, and a communications network 120 connecting one or more of the components of computing environment 100.

As shown in FIG. 1, a resource server 130 (which may also be referred to as a server computer system) and client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity having resources that are managed by or via the resource server 130. For example, the resource server 130 may be a financial institution server and the client entity may be a customer of a financial institution operating the financial institution server. The client device 110 may store software instructions that cause the client device to establish communications with the resource server 130 and, in some implementations, one or more electronic exchanges that are associated with markets (e.g., stock market, foreign exchange market, etc.).

The resource server 130 may track, manage, and maintain resources, make lending decisions, and/or lend resources to a client entity associated with the client device 110. The resources may, for example, be computing resources, such as memory or processor cycles. In at least some implementations, the resources may include stored value, such as fiat currency, which may be represented in a database. For example, the resource server 130 may be coupled to a database 135, which may be provided in secure storage. The secure storage may be provided internally within the resource server 130 or externally. The secure storage may, for example, be provided remotely from the resource server 130. For example, the secure storage may include one or more data centers. The data centers may, for example, store data with bank-grade security.

The database 135 may include records for a plurality of accounts and at least some of the records may define a quantity of resources associated with the client entity. For example, the client entity may be associated with an account having one or more records in the database 135. The records may reflect a quantity of stored resources that are associated with the client entity. Such resources may include owned resources and, in at least some implementations, borrowed resources (e.g., resources available on credit). The quantity of resources that are available to or associated with the client entity may be reflected by a balance defined in an associated record such as, for example, a bank balance.

In at least some implementations, the database 135 may store various types of information in connection with customers of a business entity that administers the resource server 130. For example, the database 135 may store customer profile data and financial account data associated with customers. The customer profile data may include, without limitation, personal information of registered customers, authentication credentials of the customers, account identifying information, and information identifying products (e.g., checking account, savings account, revolving credit line, etc.) and services (e.g., resource loan services, investment management services, etc.) that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The business entity associated with the resource server 130 may provide services that are accessible to the client entity. For example, the business entity may be a financial institution that can provide account management services, financial transaction services, and wealth management services for the client entity. In at least some implementations, the resource server 130 may be configured to provide a user interface that allows client devices 110 to access the services offered by the business entity. By way of example, the resource server 130 may be configured to provide a website or web-based portal which can be accessed via the client devices 110. The website (or portal) may include web content corresponding to various services that are offered by the business entity, and the resource server 130 may provide the web content for display on client devices 110. As another example, the resource server 130 may be associated with a software application which may be installed and/or run on the client devices 110. The software application may, for example, be a dedicated mobile banking app that is provided for use on client devices 110, and the resource server 130 may be a backend application server associated with the app.

The resource server 130 may administer a resource account management platform for managing resource accounts. The resource account management platform may be accessible via client devices 110. For example, the resource account management platform may be accessed using a web interface on the client devices 110. Additionally, or alternatively, the resource account management platform may be provided via a graphical user interface of an application, different from a web browser, operating on the client device 110. For example, an account management application may be stored in memory of the client device 110 and executed thereon for accessing features and functions of the resource account management platform.

The client devices 110, the resource server 130, and the web server 150 may be in geographically disparate locations. Put differently, the client device 110 may be remote from one or both of the resource server 130 and the web server 150. As described above, the client device 110, the resource server 130, and the web server 150 may be computer systems.

The network 120 is a computer network. In some implementations, the network 120 may be an internetwork such as may be formed of one or more interconnected computer networks. For example, the network 120 may be or may include an Ethernet network, an asynchronous transfer mode (ATM) network, a wireless network, or the like.

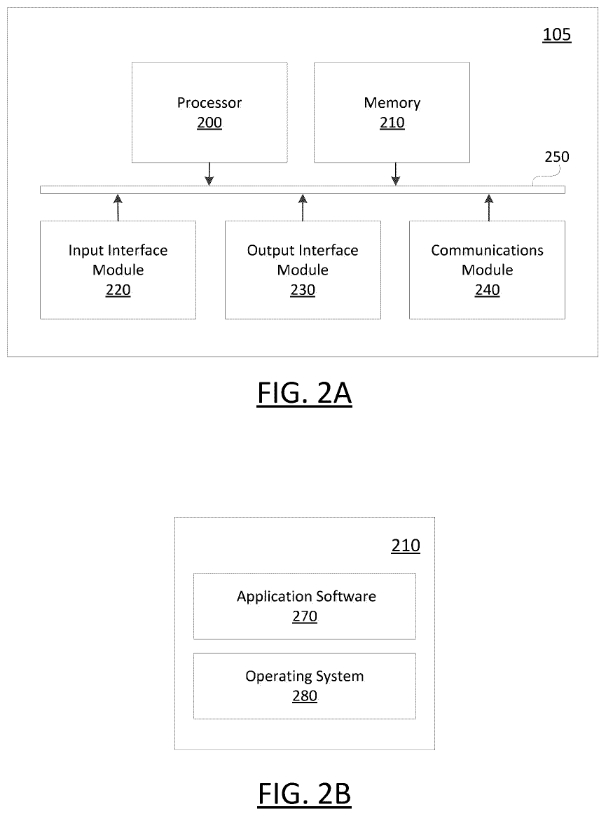

FIG. 2A is a high-level operation diagram of an example computing device 105. In some implementations, the example computing device 105 may be exemplary of one or more of the client devices 110, the resource server 130, and the web server 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Android's™, Linux™, Microsoft Windows™, or the like.

The application software 270 adapts the example computing device 105, in combination with the operating system 280, to operate as a device performing particular functions. The application software 270 may, for example, comprise a resource account management application. The resource account management application may provide various functions such as resource transfers (e.g., electronic fund transfers, etc.), display of account balances, and other account management functions. The resource account management application may, for example, be a personal finance management (PFM) application such as a banking application. A PFM application allows users to track expenses, balances, and savings, and facilitates personal budgeting. A PFM application may be used to define budget constraints (e.g., weekly or monthly spending limits), analyze historical and projected spending data, and to define various savings goals in connection with one or more banking accounts.

The resource account management application may be a stand-alone application, such as a mobile app, or integrated into another application or software module resident on the example computing device 105 as a sub-function or feature. The resource account management application is associated with a backend application server. In at least some implementations, a server which manages resource accounts associated with the customers of a business entity, such as the resource server 130 of FIG. 1, may also serve as the backend application server for the resource account management application. In particular, various functions of the resource account management application may be provided, at least in part, by a resource server associated with a bank institution. That is, the resource server may perform at least some of the backend services of the resource account management application.

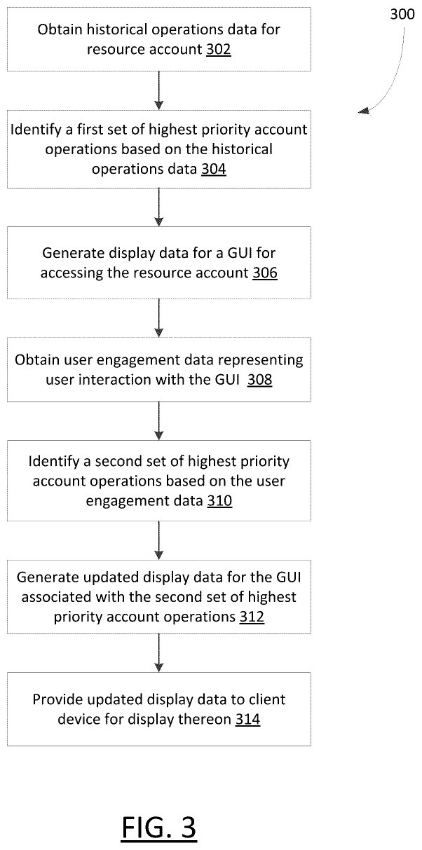

Reference is made to FIG. 3, which shows, in flowchart form, an example method 300 for providing a graphical user interface associated with a resource account management platform. Operations 302 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 300.

A computing system may receive, via a client computing device, a request to access a user interface associated with a resource account management platform. The user interface may, for example, be a website, a web application, a dedicated mobile application, and the like, for use in managing resource accounts. The computing system may be configured to detect when a user requests to launch a user interface for accessing their account on the resource account management platform. In some implementations, the computing system may determine a type or mode of the user interface that is requested by the user. Various different modes may be available for a graphical user interface of the resource account management platform. For example, an “enhanced” or “dynamic” mode may be selected for accessing a graphical user interface that is customized and adapted to change or update based on user interaction with the elements of the graphical user interface. The “enhanced” or “dynamic” mode may be contrasted with a “plain” mode which provides a static display of account information associated with the user's resource account. The user may switch between different modes of a graphical user interface by, for example, selecting a user interface control such as a toggle control.

Upon receiving a user request to launch the user interface (or a particular mode of the user interface), the computing system obtains historical operations data for a resource account, in operation 302. The historical operations data identifies, at least, account operations performed by a user in connection with the resource account. Account operations of a resource account encompass operations that are initiated by an authenticated user of the resource account on the resource account management platform. For example, account operations may include, among others, access of account data (e.g., reviewing account balances, recent transactions, and credit score), transfer of account resources (e.g., electronic fund transfers, money transfers between accounts, etc.), selection of account-specific products and services (e.g., mortgage calculator, budget calculator, loan pre-qualification, market commentary, virtual chat support, etc.), changes to account settings (e.g., updating profile image, personal preference, data visualization, etc.), and the like. As a specific example, the historical operations data for the resource account may indicate one or more banking operations initiated by a customer of a financial institution in connection with a bank account. The following is a non-exhaustive list of account operations, including features, function, products, and services, which may be accessed for a bank account: review of spending and/or savings; credit score check; access to financial news; review of account balances; electronic fund transfers; sending and checking messages and notifications; transfers between bank accounts; buying and selling investments; mobile wallet(s); bill payments; opening, accessing, and closing checking, savings, or credit accounts; stock analyst ratings; data visualizations; editing account settings; equity research reports; mortgage calculator; check deposits; loan calculator; retirement calculator; market commentary; auto insurance; GIC; cash flow calculator; customized menus and shortcuts; payment protection insurance; loans; student budget calculator; mortgage refinance; buying and selling foreign currency; overdraft protection; mutual funds; economist reports; financial goal planning; and virtual financial advisor.

In at least some implementations, the computing system may obtain historical access data in connection with at least one data record associated with the resource account. The data record may be one of a plurality of data records that are associated with the resource account. The historical access data includes data that relates to account access operations in connection with the at least one data record. The access operations may include, for example, transaction events (e.g., buy, sell, etc.) that result in modifications (e.g., debit, credit, etc.) to the at least one data record. In particular, the historical access data may include transaction events data indicating, for example, historical, transfer, trading, and/or investment activity associated with the resource account.

More generally, the historical operations data may encompass features, functions, user interaction events, and other predefined actions that were previously initiated or selected by an authenticated user of the resource account. In particular, the historical operations data may indicate all or a subset of all previous activities that occurred while a user was logged in, or otherwise authenticated, to the account on the resource account management platform.

In operation 304, the computing system identifies a first set of highest priority account operations based on the historical operations data for the resource account. The first set of highest priority account operations represents a set of account operations that are most highly prioritized by authenticated user(s) of the resource account. For example, the first set may include operations (or feature, functions, etc.) that are accessed most frequently by the authenticated user. Such operations may be identified based on monitored user interaction with the resource account. Specifically, the computing system may identify the highest priority account operations based on monitoring the user's historical use and access of the resource account. As another example, the first set may include operations that are expressly identified by the authenticated user as being highly prioritized, e.g., of high importance or value. The user may, for example, select one or more operations as being important to the user during initial setup of the resource account on the resource account management platform.

In operation 306, the computing system generates display data for a graphical user interface for accessing the resource account. The display data includes user interface elements associated with the first set of highest priority account operations. The user interface elements are selectable such that the user can access or initiate an account operation by inputting selection of the associated user interface element. The display data may comprise defined graphical elements associated with the account operations. In particular, for each account operation of the first set, the display data may include defined graphical content (e.g., image, video, text, etc.) for representing the account operation. The graphical content corresponding to the account operations may be determined, for example, by analyzing data (e.g., metadata) associated with a relevant page of the graphical user interface, or by querying a server that stores indications of web content and associated user interface elements.

In some implementations, the display data may be provided to a client computing device for presenting on a graphical user interface. That is, the display data generated in operation 306 may be provided to a client computing device upon identifying the first set of the highest priority account operations. For example, the user interface elements associated with the account operations of the first set may be caused to be displayed on a client computing device when the user requests to launch a graphical user interface for managing their resource account. In particular, the first set may represent a default set of account operations that is displayed on a home, or landing, page of the graphical user interface. The default set of account operations may be displayed when the user first authenticates to their account on the resource account management platform.

The computing system may be configured to continuously monitor user interaction with the graphical user interface. In particular, user interaction events during an authenticated account session for the resource account may be detected by the computing system. The user interaction events may comprise, for example, click events, touch gestures, text input, and the like, initiated by the user during an account session. In operation 308, the computing system obtains user engagement data representing user interaction with the graphical user interface. The user engagement data identifies previous user actions of an authenticated user for manipulating user interface elements corresponding to one or more of the account operations associated with the resource account. For example, the user engagement data identifies at least one account operation that is initiated by an authenticated user in connection with the resource account.

In operation 310, the computing system identifies a second set of highest priority account operations based on the user engagement data. The second set is different from the first set of account operations. In particular, the second set may include at least one account operation that is not included in the first set, or exclude at least one account operation that is included in the first set. The second set represents a change in priority of one or more account operations based on monitored user interactions with the graphical user interface subsequent to the selection of the first set of account operations. For example, a relative priority of an account operation may be increased based on a user's frequent access of the operation during one or more account sessions. Conversely, a relative priority of an account operation may be decreased based on infrequent use, or a user's express indication of non-interest, thereby causing another account operation of higher priority to be included in the second set.

In at least some implementations, the first and second sets of highest priority account operations may be determined based on assigning priority scores to each of one or more account operations associated with the resource account. A priority score for an account operation may represent a relative importance of the account operation for a specific user. An account operation may be associated with a high priority score if the associated feature, function, or action is of interest to the user, preferred by the user, and otherwise accessed multiple times by the user. The use of priority score values for individual users may allow for personalizing the display of interface elements to each user's individual needs, interests, and preferences. As a specific example, priority scores of account operations may be used to determine which account operations (i.e., associated user interface elements) are shown to a user and in what order they are shown.

In some implementations, a priority score for an account operation may be determined based on the user engagement data. In particular, the user engagement data may indicate, at least, a frequency of user access of an account operation and durations of the account operation, and the computing system may determine a priority score for the account operation based on the frequency and/or duration information.

In some implementations, a priority score for an account operation may be determined based on a visual priority of user interface elements for a user. In particular, the computing system may determine user-defined positional coordinates of a user interface element corresponding to an account operation on the graphical user interface, and the priority score for the account operation may be determined based on the positional coordinates.

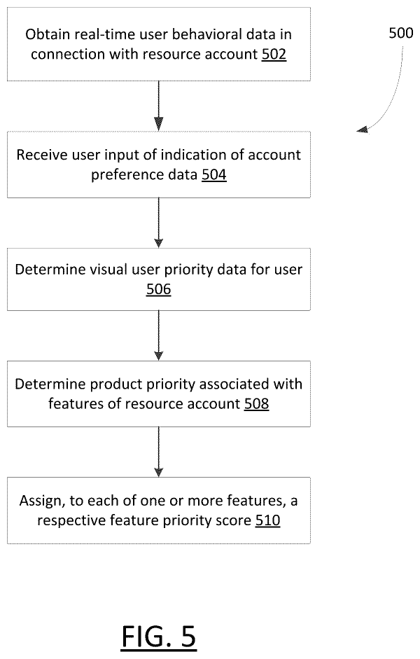

In some implementations, a priority score for an account operation may be determined based on profile information of an authenticated user of the resource account. In particular, the computing system may determine a value of a metric for measuring a difference in profile between a user of the resource account and a defined profile for a product associated with the account operation, and the priority score for an account operation associated with the product may be determined based on the metric value. The calculation of priority scores for account operations of a resource account is described in greater detail below with reference to FIG. 5.

The computing system generates updated display data for the graphical user interface associated with the second set of highest priority account operations, in operation 312. The updated display data represents a change in priority among account operations for the resource account. In at least some implementations, the computing system may determine a modified order of presenting user interface elements corresponding to one or more of the account operations associated with the resource account. A display order refers to an order of arranging user interface elements on a graphical user interface. For example, a display order in a horizontal (e.g., row) arrangement of user interface elements may be to a left-to-right ordering of the user interface elements. Similarly, a display order in a vertical arrangement of user interface elements may be a top-to-bottom ordering of the user interface elements.

The modified order of user interface elements may be determined based on relative priorities associated with account operations for the resource account. As mentioned above, the relative priorities may be represented as priority scores associated with the account operations, and the computing system may determine the modified order based on the priority scores. In some implementations, the user interface elements may be presented in decreasing order of priority scores associated with the corresponding account operations. For example, the user interface elements corresponding to account operations that are associated with higher priority may be displayed earlier in the display order than (i.e., to the left of) the user interface elements corresponding to account operations having lower priority scores.

In operation 314, the updated display data is provided to a computing device for display thereon. In particular, the updated display data may replace previously displayed information on the graphical user interface for the resource account management platform. For example, if a user re-logs in to their resource account or refreshes a home/landing page of the graphical user interface on their computing device, the information displayed on the graphical user interface may comprise the updated display data, in place of any previously presented display data associated with the account operations. As a specific example, the user interface elements associated with the account operations of the first set may be replaced by the user interface elements associated with the account operations of the second set on the graphical user interface. The updated display data may be provided automatically. For example, the display data may be updated dynamically as a user conducts account operations during one or more authenticated account sessions. Additionally, or alternatively, the updated display data may be provided responsive to certain defined triggers, such as a user command to refresh a home page, navigation back to the home page, one or more account operations initiated by an authenticated user, and the like.

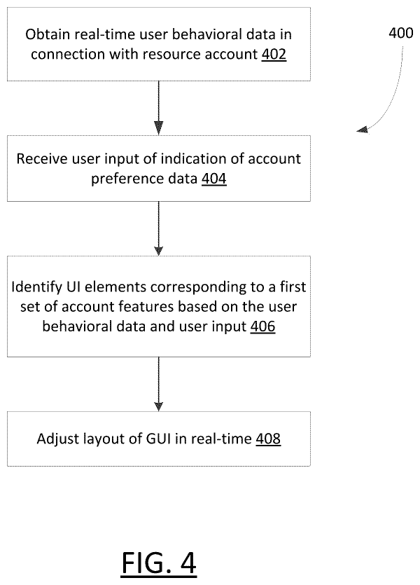

Reference is made to FIG. 4, which shows, in flowchart form, an example method 400 for real-time control of a graphical user interface associated with a resource account management platform. Operations 402 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 400. The operations of method 400 may be performed in addition to, or as alternatives of, one or more of the operations of method 300 of FIG. 3.

The computing system obtains real-time user behavioral data in connection with a resource account, in operation 402. The user behavioral data includes data describing active engagement by a user with features, functions, and/or operations associated with the resource account. In at least some implementations, the user behavioral data comprises user engagement data representing interaction with a graphical user interface associated with a resource account management platform. For example, the user behavioral data may indicate historical user actions, such as click events, touch gestures, text input, and the like, for interacting with user interface elements of the graphical user interface. In particular, for each of one or more user actions for interacting with the graphical user interface, the user behavioral data may identify, at least, type of user action, account operation corresponding to the user action, frequency of user action, and a time of detecting the user action.

In some implementations, the user behavioral data comprises user access data for features associated with the resource account. The features of a resource account may include functions, products, services, account actions, etc., associated with a resource account that can be accessed by authenticated users of the resource account. For each of one or more features associated with a resource account, the user behavioral data may indicate, at least, an identifier of the feature, a frequency of use of the feature, a duration of use of the feature, and a time of detecting user access of the feature.

In operation 404, the computing system receives user input of indication of account preference data for a user of the resource account. Specifically, an authenticated user of the resource account may provide preference data indicating the user's preferences in regard to use of the resource account. In particular, the preference data may indicate user-specified preferences for using one or more defined features associated with a resource account.

In some implementations, the preference data may be provided as part of user experience research data that is accessible by the computing system. For example, the preference data may be included in, or determined based on, user experience survey results compiled from user responses to prompts relating to usage of account features of resource accounts. The survey results may be segmented into different categories so as to classify account features based on significance to user and frequency of use. For example, account features may be classified according to level of importance of feature to users (e.g., “must-have”, “nice-to-have”, “do not need”, etc.) and frequency and/or time of use of feature (e.g., “used this month”, “not used this month”).

In operation 406, the computing system identifies user interface elements corresponding to a first set of account features for a resource account based on the user behavioral data and the user input. Specifically, the computing system determines which account features to present to authenticated users of the resource account using passive user priority information (e.g., preference data as self-reported by the users) and active user priority information (i.e., monitored feature usage data) relating to one or more account features associated with the resource account. In particular, both passive and active user priority information may be used to determine user-specific priorities associated with each of one or more account features. The first set of account features may be selected based on the relative priorities of the account features as determined based on the passive and active user priority information. The first set may, for example, include the account features that are associated with highest relative priorities. In some implementations, the relative priorities of the account features may be expressed in terms of priority scores. The first set may include the account features that have the highest priority scores among all account features that are accessible to authenticated users of the resource account.

In some implementations, a priority score for an account feature, or “feature priority score”, may include two or more component scores. For example, a feature priority score may comprise a combination of a passive user priority score and an active user priority score. The active user priority score may be a weighted combination of frequency and duration of use information for an account feature. In particular, an active user priority score may be calculated as a weighted sum of a frequency value and a duration value associated with an account feature. The frequency value for an account feature may be a count of the number of times of use of the feature during a predefined period of time, and the duration value may be a measure of duration (e.g., an average duration, measured in minutes) of use of the feature. The weights associated with the frequency value and the duration value, respectively, may be fixed or adjusted over time. Other metrics may be used for the frequency and duration values.

In operation 408, the computing system adjusts a layout associated with the graphical user interface in real-time. The layout may comprise an arrangement of user interface elements for a page (e.g., home or default page) associated with a graphical user interface for a resource account management platform. The computing system may determine an adjustment to the layout based on the priorities associated with account features of the resource account. As a particular example, the layout of a home page for a resource account management platform may be adjusted to re-arrange one or more user interface elements according to an updated order of display of the user interface elements. The updated order of display may be determined in real-time, as the computing system monitors changes to relative priorities (e.g., feature priority scores) associated with account features of a resource account.

As the layout is adjusted in real-time, the display data for the graphical user interface may be updated accordingly. That is, the computing system may cause the user interface elements associated with the graphical user interface for the resource account management platform to be displayed in accordance with the dynamically adjusted layout. In some implementations, a default layout for the graphical user interface may be changed over time, based on optimized usage patterns of existing users of the resource account. The computing system may, for example, employ machine learning model to automate the optimization process. The user behavioral data and self-reported user preference data may be fed into the model, and adjustments to user interface layout may be made in real-time based on an output of the model identifying highest priority account features.

Reference is made to FIG. 5, which shows, in flowchart form, an example method 500 for determining feature priority scores of features associated with a resource account management platform. Operations 502 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 500. The operations of method 500 may be performed in addition to, or as alternatives of, one or more operations of methods 300 and 400. In particular, the method 500 may be implemented as part of a process for determining priorities of features and functions that are offered on a resource account management platform.

In operation 502, the computing system obtains real-time user behavioral data in connection with a resource account. The user behavioral data may comprise user engagement data representing interaction with a graphical user interface associated with a resource account management platform. For example, the user behavioral data may indicate historical user actions, such as click events, touch gestures, text input, and the like, for interacting with user interface elements of the graphical user interface. Additionally, or alternatively, the user behavioral data may comprise user access data for features associated with the resource account. The features of a resource account may include functions, products, services, account actions, etc., associated with a resource account that can be accessed by authenticated users of the resource account. For each of one or more features associated with a resource account, the user behavioral data may indicate, at least, an identifier of the feature, a frequency of use of the feature, a duration of use of the feature, and a time of detecting user access of the feature.

In operation 504, the computing system receives input of account preference data for a user of the resource account. Specifically, an authenticated user of the resource account may provide preference data indicating the user's preferences in regard to use of the resource account. In particular, the preference data may indicate self-reported preferences for using one or more defined features associated with a resource account. The preference data may be provided, for example, as part of user experience research data that is accessible by the computing system. For example, the preference data may be included in, or determined based on, user experience survey results compiled from user responses to prompts relating to usage of account features of resource accounts.

In operation 506, the computing system determines, for user interface elements associated with each of one or more account features, visual priority data for the user. The visual priority of a user interface element represents an expression of a user's preference regarding the visual appearance of the user interface element. In some implementations, the visual priority data for a user interface element may comprise relative or absolute position of the user interface element in the graphical user interface. Users may be able to change the locations of user interface elements, for example, by drag-and-drop or any other suitable mechanism for moving user interface elements. The positional coordinates of user interface elements may be defined relative to a defined origin (e.g., top-left corner of display interface). The average position coordinate of each user interface element may determine an inverse priority of the associated account feature. The visual user priority of a user interface element may, in some implementations, be calculated as the invers of the magnitude of a vector representing the position of the user interface element. In this way, user interface elements that are intentionally positioned closer to a defined origin may be associated with higher priority compared to those user interface elements that are intentionally positioned farther from the defined origin. More generally, an account feature associated with a user interface element that is positionally proximal to a defined location on the graphical user interface representing a visually preferred location may have a higher priority than an account feature associated with a user interface that is positionally farther away from the defined location.

In operation 508, the computing system determines product priority associated with features of the resource account. An account feature may be associated with a product, such as a banking product (e.g., line of credit, investment management services, etc.). To calculate the product priority of a given product, the computing system may collect profile data for a user of the resource account and compare the profile data to a target client profile for the product. For users whose profiles match with given products, the priority rank for the products is increased. In some implementations, the product priority of an account feature may be calculated as the lowest squared difference between a user profile data and a target client profile data. For example, profile data fields may be assigned numerical values, and values of corresponding data fields for the user profile and target client profile may be compared in order to compute the product priority for an account feature.

In operation 510, the computing system assigns, to each of one or more features, a respective feature priority score. The feature priority score may be determined based on any one or more of: the active user priority (i.e., real-time user behavioral data), passive user priority (i.e., passive preference data), visual user priority, and the product priority. In at least some implementations, the feature priority score may be calculated as a weighted sum of an active user priority score, a passive user priority score, a visual user priority score, and a product priority score. The feature priority scores of account features may then be used in determining an arrangement of the user interface elements associated with the account features. The account features having higher priority may be moved, either automatically or responsive to defined triggers, closer to a defined location on the graphical user interface representing a visually preferred or easily accessible location.

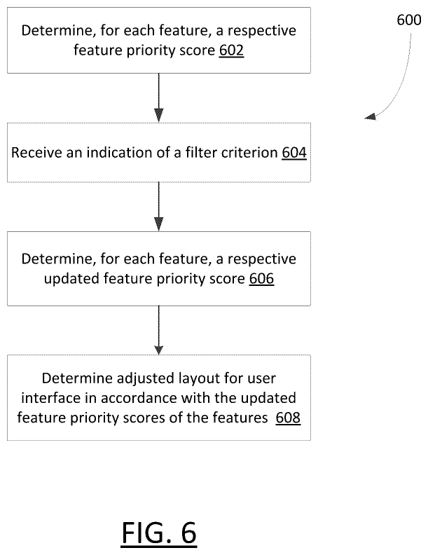

Reference is made to FIG. 6, which shows, in flowchart form, another example method 600 for real-time control of a graphical user interface associated with a resource account management platform. Operations 602 and onward may be performed by one or more processors of a computing system such as, for example, the processor 200 of one or more suitably configured instances of the example computing device 105 (FIG. 2A). In at least some implementations, a server (such as the resource server 130 of FIG. 1) that is configured to support operations for managing a plurality of resource accounts may perform all or part of the operations of method 600. The operations of method 600 may be performed in addition to, or as alternatives of, one or more of the operations of methods 300 to 500.

In operation 602, the computing system determines, for each of one or more accounts features of a resource account, a respective feature priority score. The feature priority scores may be determined in accordance with any of the techniques described above with reference to methods 300 to 500.

The computing system receives an indication of a filter criterion, in operation 604. A filter criterion is a criterion which may be used for defining a specific demographic of users for which feature priority scores are desired to be calculated. In some implementations, a filter criterion may be a demographic data such as gender, age, race, education, income, employment, and the like. The computing system may be configured to compute feature priority scores by class based on applying one or more filter criteria. By way of example, feature priority scores of account features may be computed for women, men, different age groups, different professions, etc.

In operation 606, the computing system determines, for each of one or more account features, a respective updated feature priority score. An updated feature priority score may be computed by applying one or more filter criteria. For example, the computing system may determine feature priority scores of a plurality of account features for all users of a resource account, and progressively apply one or more filter criteria to determine feature priority scores for a specific demographic of users.

In operation 608, the computing system determines an adjusted layout associated with a graphical user interface in accordance with the updated feature priority scores of the features. In particular, the display data for the graphical user interface of a resource account management platform may be progressively updated as additional filter criteria are applied to the determination of feature priority scores of account features for the resource account.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing instructions that, when executed, configure the processor to:
obtain historical operations data for a resource account, the historical operations data identifying account operations performed by a user in connection with the resource account;
identify a first set of highest priority account operations based on the historical operations data for the resource account;
generate display data for a graphical user interface for accessing the resource account, the display data including user interface elements associated with the first set of highest priority account operations;
obtain user engagement data representing user interaction with the graphical user interface, the user engagement data identifying at least one account operation;
identify a second set of highest priority account operations based on the user engagement data;
generate updated display data for the graphical user interface associated with the second set of highest priority account operations; and
provide, to a client device for display thereon, the updated display data.

2. The computing system of claim 1, wherein the historical operations data for the resource account comprises one or more banking operations performed in connection with a bank account.

3. The computing system of claim 1, wherein the first and second sets of highest priority account operations are determined based on assigning priority scores to each of one or more account operations associated with the resource account.

4. The computing system of claim 3, wherein a priority score for an account operation is determined based on the user engagement data indicating at least a frequency of the account operation and a duration of the account operation.

5. The computing system of claim 3, wherein a priority score for an account operation is determined based on user-defined positional coordinates of a user interface element corresponding to the account operation on the graphical user interface.

6. The computing system of claim 3, wherein a priority score for an account operation is determined based on a metric for measuring a difference in profile between an owner of the resource account and a defined profile for a product associated with the account operation.

7. The computing system of claim 1, wherein the user engagement data indicates user actions for manipulating user interface elements corresponding to one or more of the account operations associated with the resource account.

8. The computing system of claim 1, wherein generating the updated display data comprises determining a modified order of presenting user interface elements corresponding to one or more of the account operations associated with the resource account.

9. The computing system of claim 8, wherein the modified order of presenting the user interface elements is determined based on priority scores associated with account operations for the resource account.

10. The computing system of claim 8, wherein the user interface elements are presented in decreasing order of priority scores associated with the corresponding account operations.

11. A computer-implemented method, comprising:
obtaining historical operations data for a resource account, the historical operations data identifying account operations performed by a user in connection with the resource account;
identifying a first set of highest priority account operations based on the historical operations data for the resource account;
generating display data for a graphical user interface for accessing the resource account, the display data including user interface elements associated with the first set of highest priority account operations;
obtaining user engagement data representing user interaction with the graphical user interface, the user engagement data identifying at least one account operation;
identifying a second set of highest priority account operations based on the user engagement data;
generating updated display data for the graphical user interface associated with the second set of highest priority account operations; and
providing, to a client device for display thereon, the updated display data.

12. The method of claim 11, wherein the historical operations data for the resource account comprises one or more banking operations performed in connection with a bank account.

13. The method of claim 11, wherein the first and second sets of highest priority account operations are determined based on assigning priority scores to each of one or more account operations associated with the resource account.

14. The method of claim 13, wherein a priority score for an account operation is determined based on the user engagement data indicating at least a frequency of the account operation and a duration of the account operation.

15. The method of claim 13, wherein a priority score for an account operation is determined based on user-defined positional coordinates of a user interface element corresponding to the account operation on the graphical user interface.

16. The method of claim 13, wherein a priority score for an account operation is determined based on a metric for measuring a difference in profile between an owner of the resource account and a defined profile for a product associated with the account operation.

17. The method of claim 11, wherein the user engagement data indicates user actions for manipulating user interface elements corresponding to one or more of the account operations associated with the resource account.

18. The method of claim 11, wherein generating the updated display data comprises determining a modified order of presenting user interface elements corresponding to one or more of the account operations associated with the resource account.

19. The method of claim 18, wherein the modified order of presenting the user interface elements is determined based on priority scores associated with account operations for the resource account.

20. The method of claim 18, wherein the user interface elements are presented in decreasing order of priority scores associated with the corresponding account operations.
